(19) United States
(12) Patent Application Publication
(10) Pub. No.: US 2025/0102306 A1
(43) Pub. Date: Mar. 27, 2025

(54) METHOD FOR EVALUATING PERFORMANCE OF DETECTOR OF INTELLIGENT TRANSPORT SYSTEM, AND DEVICE FOR PERFORMING THE SAME

(71) Applicant: NOTA, INC., Daejeon (KR)

(72) Inventors: Wonjin Woo, Daejeon (KR); Hwanhyo Park, Daejeon (KR)

(21) Appl. No.: 18/892,194

(22) Filed: Sep. 20, 2024

(30) Foreign Application Priority Data
Sep. 21, 2023 (KR) 10-2023-0126410

(51) Int. Cl. G01C 21/26; G06V 10/74; G06V 10/98; G06V 20/58; G06V 20/62

(52) U.S. Cl. CPC G01C 21/26; G06V 10/761; G06V 10/98; G06V 20/58; G06V 20/625

(57) ABSTRACT

Provided is a method of evaluating performance of a detector of an intelligent transport system (ITS). The method of evaluating the performance of the detector of the ITS according to an embodiment of the present invention includes obtaining probe vehicle data (PVD) of a probe vehicle, identifying a target intersection as an evaluation target on the basis of the PVD and pre-stored intersection region information, obtaining object information of the target intersection from the ITS, evaluating the performance of the detector related to the target intersection on the basis of the PVD and the object information, and transmitting a notification indicating that there is an abnormality in the detector on the basis of a result of the evaluating of the performance of the detector.

### CROSS-REFERENCE TO RELATED APPLICATION

This application claims priority to and the benefit of Korean Patent Application No. 10-2023-0126410, filed on Sep. 21, 2023, the disclosure of which is incorporated herein by reference in its entirety.

### BACKGROUND

### 1. Field of the Invention

The present invention relates to an intelligent transport system (ITS), and more specifically, to a method of evaluating performance of a detector of an ITS that collects images related to road traffic, a device for performing the same, and/or a performance evaluation system.

### 2. Discussion of Related Art

As vehicle usage increases, traffic congestion has emerged as a social problem, and technology for precisely collecting road traffic indicators to reduce traffic congestion is being focused on. Since the road traffic indicators are calculated from image data related to road traffic, it is important to get good image data which is an analysis target. However, a photographing angle or angle of view of a detector that captures image data related to road traffic may be changed due to environmental factors such as weather and the like, and as a result, errors frequently occur in road traffic indicators calculated by analyzing the image data.

Conventionally, an operator manually evaluated the performance of a detector that captures image data related to road traffic. However, as the demand for an intelligent transport system (ITS) expands, the number of intersections where detectors are installed increases, and moreover, as a plurality of detectors are installed at each intersection, the number of detectors for which the operator should evaluate performance has increased. Therefore, the conventional method of manually evaluating an angle of view of a detector by an operator had a limitation of being significantly inefficient and taking a relatively long time to identify a detector with an abnormal angle of view because it is necessary to check for each individual detector one by one whether the angle of view of the detector had changed.

Therefore, there is a need for technology development and research on a method of evaluating performance of a detector of an ITS that is capable of automatically evaluating the performance of the detector and providing an immediate notification when an abnormality occurs in the performance of the detector, a performance evaluation device, and a performance evaluation system.

### RELATED ART DOCUMENT

### Patent Document

1. Korean Patent Registration No. 2167522 (Registered on Oct. 13, 2020)

### SUMMARY OF THE INVENTION

The present invention is directed to providing a method of evaluating performance of a detector of an intelligent transport system (ITS) that photographs road traffic, a device for performing the same, and a performance evaluation system.

The present invention is also directed to providing a method of evaluating performance of a detector of an ITS that automatically provides a notification when there is an abnormality in the detector, a device for performing the same, and a performance evaluation system.

Objects of the present invention are not limited to the above-described objects and other objects that are not described may be clearly understood by those skilled in the art from this specification and the accompanying drawings.

According to an aspect of the present invention, there is provided a method of evaluating performance of detector, which includes obtaining probe vehicle data (PVD) of a probe vehicle, identifying a target intersection as an evaluation target on the basis of the PVD and pre-stored intersection region information, obtaining object information of the target intersection from the ITS, evaluating the performance of the detector related to the target intersection on the basis of the PVD and the object information, and transmitting a notification indicating that there is an abnormality in the detector on the basis of a result of the evaluating of the performance of the detector.

According to another aspect of the present invention, there is provided an electronic device, which includes a communication module configured to receive PVD of a probe vehicle and detection data of an ITS, and a processor configured to evaluate performance of a detector of the ITS on the basis of the PVD and the detection data, wherein the processor may be configured to obtain the PVD of the probe vehicle, identify a target intersection as an evaluation target on the basis of the PVD and pre-stored information on an intersection region, obtain object information of the target intersection from the ITS, evaluate performance of the detector related to the target intersection on the basis of the PVD and the object information, and transmit a notification indicating that there is an abnormality in the detector on the basis of a result of the evaluation of the performance of the detector.

Solutions of the present invention are not limited to the above-described solutions and other solutions that are not described may be clearly understood by those skilled in the art from this specification and the accompanying drawings.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a schematic diagram illustrating a performance evaluation system according to an embodiment of the present invention;

FIG. 2 is a diagram for describing an operation of a performance evaluation system according to an embodiment of the present invention;

FIG. 3 is a flowchart illustrating a method of evaluating performance of a detector according to an embodiment of the present invention;

FIG. 4 is a diagram for describing an aspect of identifying a target intersection according to an embodiment of the present invention;

FIG. 5 is a diagram for describing an aspect of obtaining object information of a target intersection according to an embodiment of the present invention;

FIG. 6 is a detailed flowchart for describing an operation of evaluating performance of a detector related to a target intersection according to an embodiment of the present invention;

FIG. 7 is a set of diagrams for describing aspects of identifying an object corresponding to a probe vehicle in an image captured through a detector according to an embodiment of the present invention; and

FIG. 8 is a diagram for describing an aspect of evaluating performance of a detector related to a target intersection according to an embodiment of the present invention.

### DETAILED DESCRIPTION OF EXEMPLARY EMBODIMENTS

The above-described objects, features and, advantages of the present invention will be clearly understood through the following detailed description taken in conjunction with the accompanying drawings. However, while the present invention can be modified in various ways and take on various alternative forms, specific embodiments thereof are shown in the drawings and described in detail below as examples.

Like reference numerals refer to like elements in principle throughout the specification. Further, elements with the same function within the scope of the same idea shown in the drawings of each embodiment will be described using the same reference numerals, and the descriptions thereof will not be repeated.

When it is determined that detailed descriptions of related well-known functions or configurations may unnecessarily obscure the gist of the present invention, detailed descriptions thereof will be omitted. Further, the ordinal numbers (for example, first, second, etc.) used in description of the specification are used only to distinguish one element from another element.

Further, the term “module,” “unit,” “part,” or “portion” of an element used herein is assigned or incorporated for convenience of specification description, and the term itself does not have a distinct meaning or role.

As used herein, the singular forms “a” and “an” are intended to include the plural forms as well, unless the context clearly indicates otherwise.

It will be further understood that the terms “comprise,” “comprising,” “include,” and/or “including” used herein specify the presence of stated features or elements, but do not preclude the presence or addition of one or more other features or elements.

Sizes of elements in the drawings may be exaggerated for convenience of explanation. In other words, since sizes and thicknesses of elements in the drawings are arbitrarily illustrated for convenience of explanation, the following embodiments are not limited thereto.

When a certain embodiment may be implemented differently, a specific process order may be performed differently from the described order. For example, two consecutively described processes may be performed substantially at the same time or performed in an order opposite to the described order.

In the following embodiments, when a first element is referred to as being “connected” to a second element, it includes not only a case where the two elements are “directly connected,” but also a case where the two elements are “indirectly connected” with a third element interposed therebetween. For example, in this specification, when a first element is referred to as being “electrically connected” to a second element, it includes not only a case where the two elements are “directly electrically connected,” but also a case where the two elements are “indirectly electrically connected” with a third element interposed therebetween.

A method of evaluating performance of a detector according to an embodiment of the present invention may include obtaining probe vehicle data (PVD) of a probe vehicle, identifying a target intersection as an evaluation target on the basis of the PVD and pre-stored intersection region information, obtaining object information of the target intersection from an intelligent transport system (ITS), evaluating the performance of the detector related to the target intersection on the basis of the PVD and the object information, and transmitting a notification indicating that there is an abnormality in the detector on the basis of a result of the evaluating of the performance of the detector.

According to an embodiment of the present invention, the evaluating of the performance of the detector related to the target intersection may further include comparing the PVD with the object information and determining whether an object corresponding to the probe vehicle in an image captured through the detector of the ITS is identified, and when it is determined that the object corresponding to the probe vehicle is identified, determining that there is no abnormality in the performance of the detector, and when it is determined that the object corresponding to the probe vehicle is not identified, determining that there is an abnormality in the performance of the detector.

According to an embodiment of the present invention, the determining whether the object corresponding to the probe vehicle is identified may further include comparing an object trajectory calculated from the PVD with candidate object trajectories calculated from the object information, and when a similarity of the candidate object trajectories and the object trajectory calculated from the PVD is greater than or equal to a threshold value, determining that the object corresponding to the probe vehicle is identified, and when the similarity of the candidate object trajectories and the object trajectory calculated from the PVD is less than the threshold value, determining that the object corresponding to the probe vehicle is not identified.

According to an embodiment of the present invention, the evaluating of the performance of the detector related to the target intersection may further include comparing the PVD with the object information and identifying an object corresponding to the probe vehicle in an image captured through the detector of the ITS, calculating a similarity between the object information on the identified object and the PVD, and evaluating the performance of the detector on the basis of the calculated similarity.

According to an embodiment of the present invention, the identifying of the target intersection may further include identifying an intersection corresponding to the information on the intersection region into which the probe vehicle enters as the target intersection on the basis of longitude and latitude data included in the PVD and the information on the intersection region.

According to an embodiment of the present invention, the identifying of the object corresponding to the probe vehicle may further include comparing license plate information pre-linked to terminal ID data included in the PVD with license plate data included in the object information, and determining an object corresponding to the license plate data included in the object information that matches the pre-linked license plate information as the object corresponding to the probe vehicle.

According to an embodiment of the present invention, the identifying of the object corresponding to the probe vehicle may further include comparing an object trajectory calculated from longitude and latitude data included in the PVD with candidate object trajectories of a plurality of objects that are calculated from longitude and latitude data of the object information, and identifying an object corresponding to a candidate object trajectory with the highest similarity to the object trajectory calculated from the PVD, among the candidate object trajectories, as the object corresponding to the probe vehicle.

According to an embodiment of the present invention, the calculating of the similarity between the object information on the identified object and the PVD may further include calculating a first similarity score between longitude and latitude data included in the object information of the identified object and longitude and latitude data included in the PVD, calculating a second similarity score between azimuth data included in the object information of the identified object and azimuth data included in the PVD, and calculating a third similarity score between speed data included in the object information of the identified object and speed data included in the PVD.

According to an embodiment of the present invention, the evaluating of the performance of the detector may further include, when at least one of the first to third similarity scores is lower than a preset first threshold score, determining that there is an abnormality in the performance of the detector.

According to an embodiment of the present invention, the evaluating of the performance of the detector may further include calculating a summed similarity score on the basis of the first to third similarity scores, and when the summed similarity score is lower than a preset second threshold score, determining that there is an abnormality in the performance of the detector.

According to an embodiment of the present invention, the PVD may include terminal ID data, time data, longitude and latitude data, azimuth data, or speed data of the probe vehicle.

According to an embodiment of the present invention, the object information may include longitude and latitude data, azimuth data, speed data, or license plate data of at least one object detected from the image of the ITS.

According to an embodiment of the present invention, the notification may include identification information of the target intersection, and identification information of the detector which is abnormal.

According to an embodiment of the present invention, the obtaining of the PVD of the probe vehicle may further include transmitting identification information of a terminal that is mounted on the probe vehicle and pre-stored in an electronic device, and receiving the PVD corresponding to the identification information of the terminal.

According to an embodiment of the present invention, the obtaining of the object information of the target intersection from the ITS may further include calculating an entry time point at which the probe vehicle enters the target intersection and an exit time point at which the probe vehicle exits from the target intersection on the basis of time data of the PVD, and obtaining the object information detected from an image corresponding to a section between the entry time point and the exit time point from the ITS.

According to an embodiment of the present invention, a computer-readable recording medium on which a program for performing the method of evaluating performance of the detector 1 is recorded may be provided.

An electronic device according to the embodiment of the present invention may include a communication module configured to receive PVD of a probe vehicle and detection data of an ITS, and a processor configured to evaluate performance of a detector of the ITS on the basis of the PVD and the detection data, wherein the processor may be configured to obtain the PVD of the probe vehicle, identify a target intersection as an evaluation target on the basis of the PVD and pre-stored information on an intersection region, obtain object information of the target intersection from the ITS, evaluate performance of the detector related to the target intersection on the basis of the PVD and the object information, and transmit a notification indicating that there is an abnormality in the detector on the basis of a result of the evaluation of the performance of the detector.

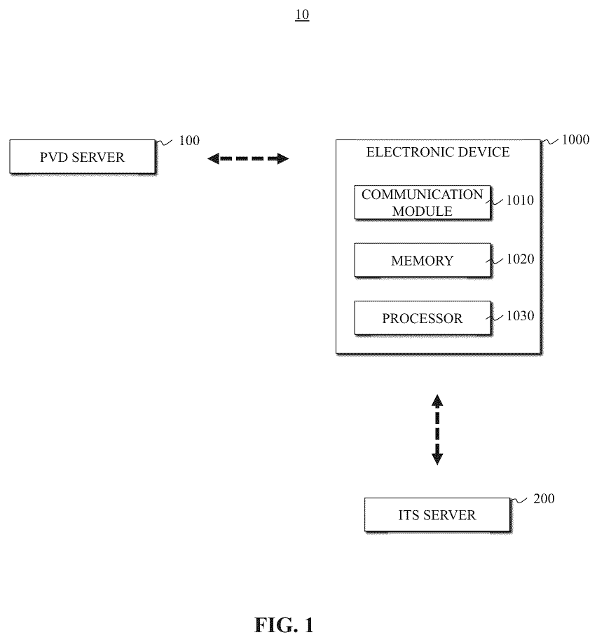

Hereinafter, a method of evaluating performance of a detector of an ITS, a performance evaluation device (or referred to as an electronic device) for performing the same, and a performance evaluation system according to embodiments of the present invention will be described in more detail with reference to FIGS. 1 to 8.

FIG. 1 is a schematic diagram illustrating a performance evaluation system 10 of a detector of an ITS according to an embodiment of the present invention.

The performance evaluation system 10 of the detector of the ITS according to the embodiment of the present invention may perform an operation of evaluating performance (or an angle of a camera) of a detector of an ITS server 200 that captures images related to road traffic. Specifically, the performance evaluation system 10 may be implemented to evaluate the performance of the detector of the ITS server 200 using PVD received from a PVD server 100.

Referring to FIG. 1, the performance evaluation system 10 may include the PVD server 100, the ITS server 200, and/or an electronic device 1000 (or may be referred to as a performance evaluation device).

The PVD server 100 according to the embodiment of the present invention may be configured to obtain and store PVD of a plurality of probe vehicles. In this case, the PVD server 100 may perform an operation of receiving terminal identification information of the probe vehicle from the electronic device 1000 and transmitting PVD corresponding to the terminal identification information of the probe vehicle to the electronic device 1000.

The ITS server 200 according to the embodiment of the present invention may be configured to capture images related to road traffic using a detector (or a camera), analyze the captured images, and calculate traffic information related to a traffic volume, a pedestrian volume, an occupancy rate, a queue length, and a section average speed and/or object information related to vehicle objects in the images. In this case, the ITS server 200 may perform an operation of transmitting the traffic information and/or the object information to the electronic device 1000 in response to a collection request received from the electronic device 1000.

The electronic device 1000 may perform an operation of identifying a target intersection as an evaluation target on the basis of the PVD of the probe vehicle received from the PVD server 100 and pre-stored intersection region information. Furthermore, the electronic device 1000 may be implemented to receive the traffic information and/or the object information related to the identified target intersection from the ITS server 200. Furthermore, the electronic device 1000 may perform an operation of evaluating the performance of the detector related to the target intersection on the basis of the PVD and the object information and transmitting a notification to an external server, including the ITS server 200, on the basis of a result of the evaluation. Meanwhile, the electronic device 1000 may be any type of server, personal computer (PC), tablet computer, smartphone, smart watch, personal digital assistant (PDA), and/or a combination thereof. Furthermore, the electronic device 1000 may encompass a combination of one or more servers.

The electronic device 1000 may include a communication module 1010, a memory 1020, and/or a processor 1030.

The communication module 1010 of the electronic device 1000 may communicate with any external device or an external server. For example, the electronic device 1000 may transmit the terminal identification information of the probe vehicle to the PVD server 100 and receive the PVD of the probe vehicle corresponding to the terminal identification information from the PVD server 100, through the communication module 1010. For example, the electronic device 1000 may transmit a request for collecting object information (or traffic information) to the ITS server 200 and receive the transmitted object information from the ITS server 200 in response to the collection request, through the communication module 1010. For example, the electronic device 1000 may transmit a notification related to the result of the evaluation of the performance of the detector to the ITS server 200 through the communication module 1010. However, this is only exemplary, and the electronic device 1000 may transmit or receive any appropriate data and/or commands to or from any component included in the performance evaluation system 10 through the communication module 1010.

The electronic device 1000 may access a network through the communication module 1010 to transmit or receive various types of data. The communication module 1010 may largely include a wired-type communication module 1010 and a wireless-type communication module 1010. Since the wired-type communication module 1010 and the wireless-type communication module 1010 have their own advantages and disadvantages, in some cases, the wired-type communication module 1010 and the wireless-type communication module 1010 may be provided together to the electronic device 1000. Here, in the case of the wireless-type communication module 1010, a wireless local area network (WLAN) type communication method such as Wi-Fi may be mainly used. Alternatively, in the case of the wireless-type communication module 1010, cellular communication, such as long-term evolution (LTE) or 5th-generation (5G) communication method, may be used. However, a wireless communication protocol is not limited to the above-described example, and any appropriate wireless type of communication method may be used. In the case of the wired-type communication module 1010, a LAN or Universal Serial Bus (USB) communication is a representative example, but other methods may also be used.

Various types of information may be stored in the memory 1020 of the electronic device 1000. Various types of data may be temporarily or semi-permanently stored in the memory 1020. Examples of the memory 1020 may include a hard disk drive (HDD), a solid state drive (SSD), a flash memory, a read-only memory (ROM), a random access memory (RAM), etc. The memory 1020 may be provided as embedded in the electronic device 1000 or in a detachable form. Various types of data necessary for the operation of the electronic device 1000, including an operating program (OS) for driving the electronic device 1000 or a program for operating each component of the electronic device 1000, may be stored in the memory 1020.

The processor 1030 may control the overall operation of the electronic device 1000. For example, the processor 1030 may control the overall operation of the electronic device 1000, including an operation of obtaining PVD of a probe vehicle, an operation of identifying a target intersection as an evaluation target, an operation of obtaining object information of the target intersection from an ITS server, an operation of evaluating performance of a detector related to the target intersection on the basis of the PVD and the object information, and/or an operation of transmitting a notification indicating that there is an abnormality in the detector on the basis of a result of the evaluation of the performance of the detector, which will be described below. Specifically, the processor 1030 may load and execute a program for the overall operation of the electronic device 1000 from the memory 1020. The processor 1030 may be implemented as an application processor (AP), a central processing unit (CPU), a microcontroller unit (MCU), or a similar device depending on hardware, software, or a combination thereof. In this case, the processor 1030 may be provided in the form of an electronic circuit that processes electrical signals and performs a control function as hardware, and may be provided in the form of a program or code that drives a hardware circuit as software.

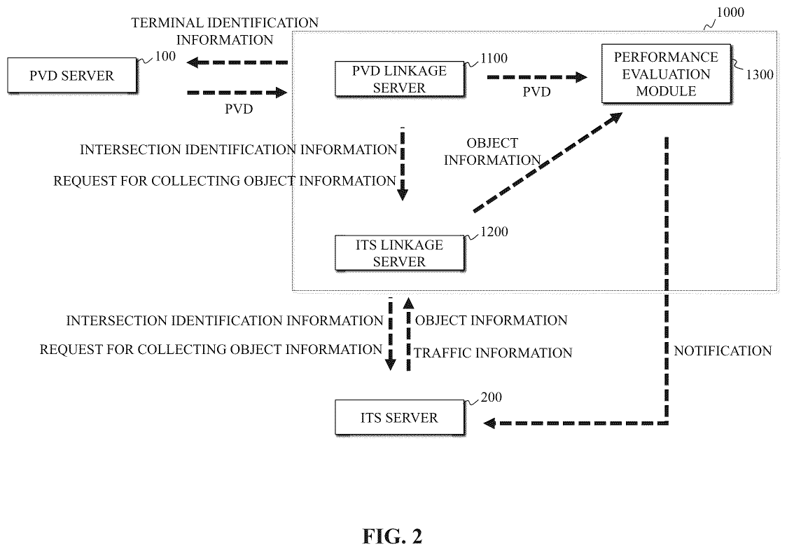

FIG. 2 is a diagram for describing an operation of a performance evaluation system 10 according to an embodiment of the present invention.

Referring to FIG. 2, an electronic device 1000 (or referred to as a performance evaluation device) according to the embodiment of the present invention may include a PVD linkage server 1100, an ITS linkage server 1200, and/or a performance evaluation module 1300.

The PVD linkage server 1100 according to the embodiment of the present invention may be a server that communicates with a PVD server 100 to obtain PVD of a probe vehicle. Specifically, the PVD linkage server 1100 may transmit terminal identification information (e.g., a terminal ID) of a reliable probe vehicle to the PVD server 100 through a communication module 1010. Furthermore, the PVD linkage server 1100 may receive PVD corresponding to the terminal identification information of the probe vehicle from the PVD server 100 through the communication module 1010. Meanwhile, the PVD may include terminal ID data, time data, longitude and latitude data (Below expressed as longitude/latitude data), azimuth data, speed data, and/or altitude data of the probe vehicle. However, this is only exemplary, and the PVD may include any appropriate data related to the probe vehicle, including data related to whether the probe vehicle is empty or full and/or data related to whether a terminal is charged.

The PVD linkage server 1100 according to the embodiment of the present invention may identify a target intersection as an evaluation target by determining whether the probe vehicle enters a specific intersection region among a plurality of intersections on the basis of the PVD. Specifically, the PVD linkage server 1100 may be implemented to identify an intersection where the probe vehicle enters as the target intersection as an evaluation target, on the basis of the PVD and the intersection region information pre-stored in the PVD linkage server 1100. In this case, the PVD linkage server 1100 may be implemented to transmit an identification information of the identified target intersection (e.g., ID data of the target intersection) and a request for collecting object information related to the target intersection to the ITS linkage server 1200, which will be described below, through the communication module 1010. Furthermore, the PVD linkage server 1100 may be implemented to transmit the PVD to a performance evaluation module 1300, which will be described below, through the communication module 1010.

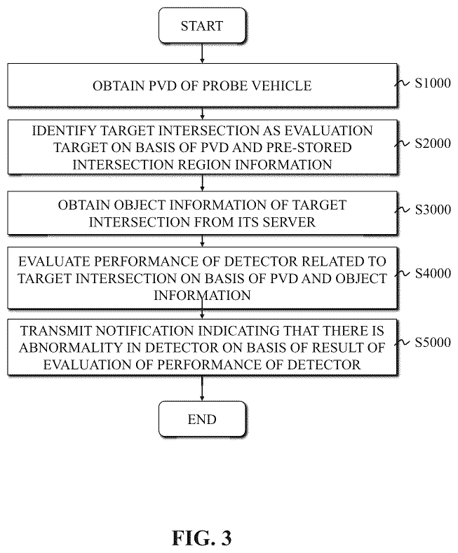

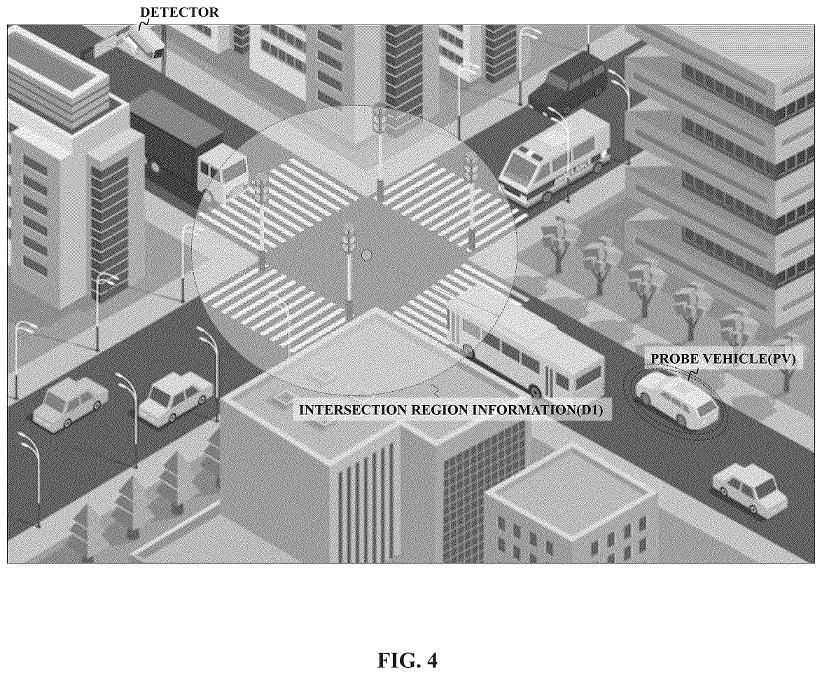

An operation of the PVD linkage server 1100 will be described in more detail with reference to FIGS. 3 and 4.

The ITS linkage server 1200 according to the embodiment of the present invention may be a server that communicates with the ITS server 200 to obtain traffic information and/or object information calculated through the ITS server 200. Specifically, the ITS linkage server 1200 may be implemented to transmit an identification information of a target intersection (e.g., ID data of the target intersection) and a request for collecting object information related to the target intersection to the ITS server 200 through the communication module 1010 in response to a request for collecting the object information related to the target intersection received by the PVD linkage server 1100.

Furthermore, the ITS linkage server 1200 may receive the object information related to the target intersection or traffic information from the ITS server 200 through the communication module 1010. The object information may include longitude/latitude data, azimuth data, speed data, license plate data, and vehicle model data of one or more objects (e.g., vehicle objects) that are detected from images captured through a detector of an ITS, and/or identification information of the detector through which the objects are detected. The traffic information may include any appropriate road traffic indicators, including a traffic volume, a pedestrian volume, an occupancy rate, a queue length, and/or a section average speed.

Furthermore, the ITS linkage server 1200 may be implemented to calculate an entry time point at which the probe vehicle enters the target intersection, and an exit time point at which the probe vehicle exits the target intersection, and accumulate and store the object information or traffic information detected from the images of the ITS that corresponds to a section between the entry time point and the exit time point. In this case, the ITS linkage server 1200 may be configured to transmit the object information or traffic information corresponding to the section between the entry time point and the exit time point to the performance evaluation module 1300 through the communication module 1010.

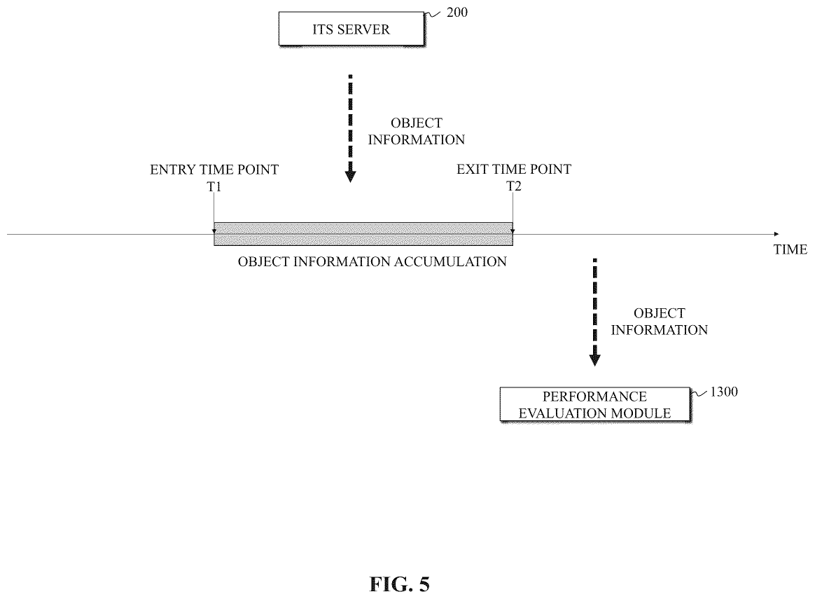

An operation of the ITS linkage server 1200 will be described in more detail with reference to FIGS. 3 and 5.

The performance evaluation module 1300 according to the embodiment of the present invention may perform an operation of evaluating the performance of the detector related to the target intersection on the basis of the PVD and the object information. Specifically, the performance evaluation module 1300 may be implemented to identify an object corresponding to the probe vehicle in the image captured through the detector related to the target intersection, by comparing the PVD with the object information.

According to one embodiment, the performance evaluation module 1300 may be implemented to determine the performance of the detector depending on whether an object corresponding to the probe vehicle is identified in the image captured through the detector of the ITS. For example, when it is determined that the object corresponding to the probe vehicle is identified, the performance evaluation module 1300 may determine that there is no abnormality in the performance of the detector. For example, when it is determined that the object corresponding to the probe vehicle is not identified, the performance evaluation module 1300 may determine that there is an abnormality in the performance of the detector.

According to one embodiment, the performance evaluation module 1300 may be implemented to calculate a similarity between object information on the identified object (i.e., the object corresponding to the probe vehicle) and PVD of the probe vehicle, and evaluate the performance of the detector on the basis of the calculated similarity. For example, the performance evaluation module 1300 may calculate a first similarity score by comparing longitude/latitude data included in the object information on the identified object with longitude/latitude data included in the PVD of the probe vehicle. For example, the performance evaluation module 1300 may calculate a second similarity score by comparing azimuth data included in the object information on the identified object with azimuth data included in the PVD of the probe vehicle. For example, the performance evaluation module 1300 may calculate a third similarity score by comparing speed data included in the object information on the identified object with speed data included in the PVD of the probe vehicle. In this case, the performance evaluation module 1300 may determine whether there is an abnormality in the performance of the detector of the ITS on the basis of the first to third similarity scores.

Furthermore, the performance evaluation module 1300 according to the embodiment of the present invention may be implemented to transmit a notification indicating that there is an abnormality in the detector on the basis of a result of the evaluation of the performance of the detector to the ITS server 200 through the communication module 1010. The notification may include any appropriate form of information related to the evaluation of the performance of the detector, including identification information of the target intersection (i.e., ID of the target intersection), identification information of the detector (i.e., ID of the detector) determined that there is an abnormality, information (e.g., information on the similarity between the object information and the PVD) used to evaluate the performance of the detector, and/or any appropriate form of message indicating that there is an abnormality in the detector.

An operation of the performance evaluation module 1300 will be described in more detail with reference to FIGS. 3 and 6 to 8.

Hereinafter, the method of evaluating the performance of the detector of the ITS according to an embodiment of the present invention will be described in more detail with reference to FIGS. 3 to 8. Meanwhile, in describing the method of evaluating the performance of the detector of the ITS, descriptions of some embodiments that overlap the content described above with reference to FIGS. 1 and 2 may be omitted. However, this is only for convenience of description and should not be construed for purposes of limitation.

FIG. 3 is a flowchart illustrating a method of evaluating performance of a detector performed by an electronic device 1000 according to an embodiment of the present invention.

A method of evaluating the performance of the detector according to the embodiment of the present invention may include an operation S1000 of obtaining PVD of a probe vehicle, an operation S2000 of identifying a target intersection as an evaluation target on the basis of the PVD and pre-stored intersection region information, an operation S3000 of obtaining object information of the target intersection from an ITS server 200, an operation S4000 of evaluating the performance of the detector related to the target intersection on the basis of the PVD and the object information, and/or an operation S5000 of transmitting a notification indicating that there is an abnormality in the detector on the basis of a result of the evaluation of the performance of the detector.

In the operation S1000 of obtaining the PVD of the probe vehicle, the electronic device 1000 may obtain the PVD of the probe vehicle from a PVD server 100 through a communication module 1010. Specifically, a PVD linkage server 1100 of the electronic device 1000 may transmit terminal identification information (e.g., a terminal ID), which is pre-stored in the PVD linkage server 1100, of a terminal mounted on a reliable probe vehicle to the PVD server 100. In this case, the PVD linkage server 1100 may receive the PVD of the probe vehicle corresponding to the terminal identification information of the probe vehicle from the PVD server 100. Meanwhile, the PVD may include any appropriate data related to the probe vehicle, including terminal ID data, time data, longitude/latitude data, azimuth data, speed data, and/or altitude data of the probe vehicle.

In the operation S2000 of identifying the target intersection as an evaluation target on the basis of the PVD and the pre-stored intersection region information, the electronic device 1000 may identify an intersection where the probe vehicle enters a specific intersection region among a plurality of intersections as the target intersection as an evaluation target on the basis of the PVD of the probe vehicle received in operation S1000 and the pre-stored intersection region information.

FIG. 4 is a diagram for describing an aspect of identifying a target intersection according to an embodiment of the present invention.

Specifically, the PVD linkage server 1100 of the electronic device 1000 may be implemented to identify an intersection corresponding to information DI on an intersection region where a probe vehicle PV enters as a target intersection as an evaluation target on the basis of PVD of the probe vehicle PV and intersection region information pre-stored in the PVD linkage server 1100.

For example, the pre-stored intersection region information may include longitude/latitude coordinates of the intersection region. In this case, the PVD linkage server 1100 may identify the intersection corresponding to the intersection region where the probe vehicle enters as the target intersection as an evaluation target by comparing longitude/latitude data of the probe vehicle included in the PVD with the longitude/latitude coordinates of the intersection region of the intersection region information.

For example, the pre-stored intersection region information may include center coordinates (longitude/latitude coordinates) of the intersection and a predetermined radius from the center coordinates. In this case, the PVD linkage server 1100 may determine whether the probe vehicle enters the intersection region depending on whether a distance between the longitude/latitude data of the probe vehicle included in the PVD and the center coordinates of the intersection is less than or equal to the predetermined radius. For example, when it is determined that the distance between the longitude/latitude data of the probe vehicle included in the PVD and the center coordinates of the intersection is less than or equal to the predetermined radius, the PVD linkage server 1100 may determine that the probe vehicle enters a specific intersection region, and identify the intersection corresponding to the intersection region where the probe vehicle enters as the target intersection.

Meanwhile, in FIG. 4, an aspect in which the probe vehicle enters the intersection has been mainly described. However, this is only for convenience of description and the content of determining whether the probe vehicle enters the intersection on the basis of the PVD and the intersection region information described above in order to determine a time point when the probe vehicle exits from the target intersection.

Furthermore, when the target intersection as an evaluation target is identified, the PVD linkage server 1100 of the electronic device 1000 may be implemented to transmit the identification information of the target intersection (e.g., ID of the target intersection) and a request for collecting the object information collected through the ITS to the ITS linkage server 1200 and/or the ITS server 200. For example, the PVD linkage server 1100 may transmit the identification information of the target intersection and/or the request for collecting the object information to the ITS linkage server 1200. In this case, the ITS linkage server 1200 may transmit the identification information of the target intersection and/or the request for collecting the object information to the ITS server 200. However, this is only exemplary, and the electronic device 1000 according to the embodiment of the present invention may be implemented to transmit the identification information of the target intersection and/or the request for collecting the object information to the ITS server 200 and obtain the object information from the ITS server 200 through any appropriate aspect.

In the operation S3000 of obtaining the object information of the target intersection from the ITS server 200, the electronic device 1000 may obtain the object information of the target intersection transmitted from the ITS server 200 in response to the request for collecting the object information. Specifically, the ITS linkage server 1200 of the electronic device 1000 may transmit the identification information of the target intersection transmitted from the PVD linkage server 1100 or the request for collecting the object information related to the target intersection, to the ITS server 200 through the communication module 1010. In this case, the ITS linkage server 1200 may receive object information of objects (e.g., vehicle objects) in images of the target intersection that are obtained through the detector or the traffic information, from the ITS server 200. As described above, the object information may include longitude/latitude data, azimuth data, speed data, license plate data, and vehicle model data of the objects in the images of the target intersection that are obtained through the detector, and/or identification information (i.e., ID of the detector) of the detector through which the objects are detected. As described above, the traffic information may include any appropriate road traffic indicators, including a traffic volume, a pedestrian volume, an occupancy rate, a queue length, and/or a section average speed.

FIG. 5 is a diagram for describing an aspect of obtaining object information of a target intersection according to an embodiment of the present invention.

The ITS linkage server 1200 of the electronic device 1000 according to the embodiment of the present invention may be implemented to accumulate object information (or traffic information) from a time point at which the probe vehicle enters the target intersection to a time point at which the probe vehicle exits the target intersection, and transmit the accumulated object information to the performance evaluation module 1300 after the probe vehicle left the target intersection. More specifically, the ITS linkage server 1200 may calculate an entry time point t1 at which a probe vehicle enters the target intersection and an exit time point t2 at which the probe vehicle exits the target intersection using time data included in PVD. Furthermore, the ITS linkage server 1200 may be implemented to obtain the object information detected from images captured in a section between the entry time point and the exit time point from the ITS server 200 and accumulate the object information in a memory. In this case, the ITS linkage server 1200 may transmit the accumulated object information to the performance evaluation module 1300 after the probe vehicle left the target intersection. However, this is only exemplary, and the ITS linkage server 1200 according to the embodiment of the present invention may be implemented to transmit the object information received from the ITS server 200 to the performance evaluation module 1300 through any appropriate method.

In the operation S4000 of evaluating the performance of the detector related to the target intersection on the basis of the PVD and the object information, the electronic device 1000 may be implemented to evaluate the performance of the detector of the ITS server 200 related to the target intersection on the basis of the PVD received from the PVD server 100 and the object information received from the ITS server 200. Specifically, the performance evaluation module 1300 of the electronic device 1000 may evaluate whether there is an abnormality in an angle of view of the detector related to the target intersection by comparing the PVD of the probe vehicle with the object information on the object corresponding to the probe vehicle of the target intersection received from the ITS server 200.

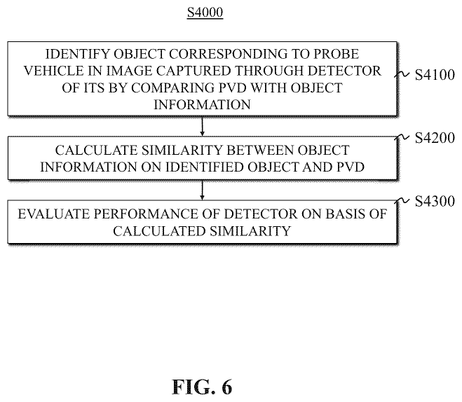

FIG. 6 is a detailed flowchart for describing an operation S4000 of evaluating the performance of the detector related to the target intersection according to an embodiment of the present invention.

The operation S4000 of evaluating the performance of the detector related to the target intersection according to the embodiment of the present invention may further include an operation S4100 of identifying the object corresponding to the probe vehicle in the image captured through the detector of the ITS by comparing the PVD with the object information, an operation S4200 of calculating a similarity between the object information on the identified object and the PVD, and/or an operation S4300 of evaluating the performance of the detector on the basis of the calculated similarity.

In the operation S4100 of identifying the object corresponding to the probe vehicle in the image captured through the detector of the ITS by comparing the PVD with the object information, the performance evaluation module 1300 of the electronic device 1000 may be implemented to identify the object corresponding to the probe vehicle in the image captured through the detector of the ITS by comparing license plate information of the probe vehicle obtained from the PVD with license plate information included in the object information or comparing an object trajectory of the probe vehicle calculated from the PVD with an object trajectory of the object in the image calculated from the object information.

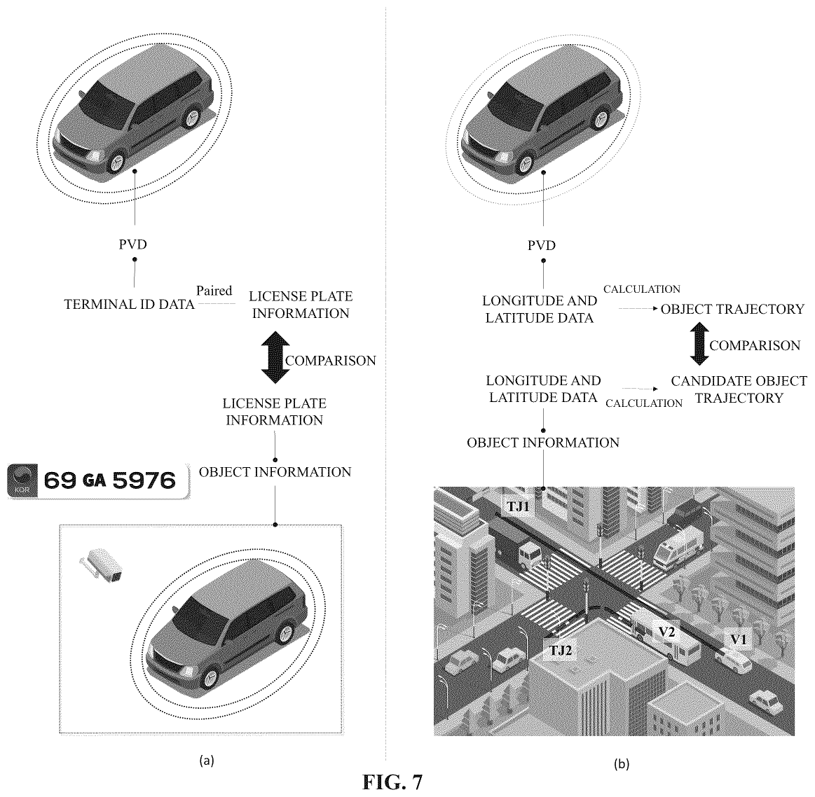

FIG. 7 is a set of diagrams for describing aspects of identifying an object corresponding to a probe vehicle in an image captured through a detector according to an embodiment of the present invention.

For example, referring to FIG. 7A, the performance evaluation module 1300 may determine an object corresponding to license plate data included in the object information matching pre-linked license plate information as the object corresponding to the probe vehicle by comparing the license plate information of the probe vehicle previously linked to the terminal identification information (e.g., terminal ID data) included in the PVD with the license plate data (i.e., license plate data of a vehicle object photographed through the detector of the ITS) included in the object information. Meanwhile, the performance evaluation module 1300 may determine an object corresponding to the object information including the license plate data with the highest similarity to the pre-linked license plate information as the object corresponding to the probe vehicle.

For example, referring to FIG. 7B, the performance evaluation module 1300 may identify an object corresponding to a candidate object trajectory with the highest similarity to an object trajectory calculated from the PVD as the object corresponding to the probe vehicle by comparing an object trajectory of the probe vehicle calculated from the longitude/latitude data included in the PVD with candidate object trajectories calculated from each piece of longitude/latitude data of a plurality of objects included in the object information. For example, in the case of a first vehicle object V1, a first candidate object trajectory TJ1 may be calculated from the longitude/latitude data of the object information, and in the case of a second vehicle object V2, a second candidate object trajectory TJ2 may be calculated from the longitude/latitude data of the object information. In this case, the performance evaluation module 1300 may identify an object (e.g., the first vehicle object V1) having a candidate object trajectory (e.g., the first candidate object trajectory TJ1 in the case of FIG. 7B) with the highest similarity to the object trajectory calculated from the PVD as the object corresponding to the probe vehicle by comparing an object trajectory calculated from the longitude/latitude data included in the PVD of the probe vehicle (e.g., see PV of FIG. 4) with candidate object trajectories TJ1 and TJ2.

For example, referring to FIG. 7B, the performance evaluation module 1300 may identify the object corresponding to the candidate object trajectory of which a similarity to the object trajectory calculated from the PVD is a threshold value or more as the object corresponding to the probe vehicle by comparing the object trajectory of the probe vehicle calculated from the longitude/latitude data included in the PVD with the candidate object trajectories calculated from each piece of longitude/latitude data of the plurality of objects included in the object information. For example, the performance evaluation module 1300 may identify an object (e.g., the first vehicle object V1) having a candidate object trajectory (e.g., the first candidate object trajectory TJ1 in the case of FIG. 7B) of which the similarity to the object trajectory calculated from the PVD is the threshold value or more as the object corresponding to the probe vehicle by comparing the object trajectory calculated from the longitude/latitude data included in the PVD of the probe vehicle (e.g., PV of FIG. 4) with the candidate object trajectories TJ1 and TJ2. For example, the performance evaluation module 1300 may determine that an object (e.g., the second vehicle object V2) having the candidate object trajectory (e.g., the second candidate object trajectory TJ2 in the case of FIG. 7B) of which a similarity to the object trajectory calculated from the PVD is less than the threshold value is an object that does not correspond to the probe vehicle by comparing the object trajectory calculated from the longitude/latitude data included in the PVD of the probe vehicle (e.g., PV of FIG. 4) with the candidate object trajectories TJ1 and TJ2. On the other hand, the performance evaluation module 1300 may determine that an object corresponding to the probe vehicle is not identified when the similarity of the candidate object trajectory and the object trajectory calculated from the PVD is less than the threshold value (i.e., when the similarity between each of the candidate object trajectories and the object trajectory calculated from the PVD is less than the threshold value) by comparing the object trajectory calculated from the longitude/latitude data included in the PVD of the probe vehicle with the candidate object trajectories. Furthermore, when it is determined that the object corresponding to the probe vehicle is not identified, the performance evaluation module 1300 may be implemented to determine that there is an abnormality in the performance of the detector, as will be described below. However, this is only exemplary, and the performance evaluation module 1300 according to the embodiment of the present invention may be implemented to identify the object corresponding to the probe vehicle using any appropriate method.

In the operation S4200 of calculating the similarity between the object information on the identified object and the PVD, the performance evaluation module 1300 of the electronic device 1000 may calculate the similarity between the object information and the PVD by comparing the object information on the object identified through in operation S4100 with the PVD of the probe vehicle.

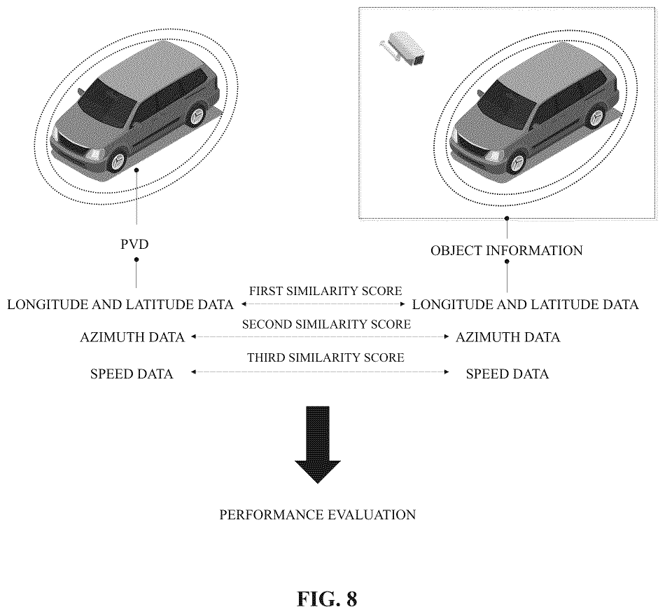

FIG. 8 is a diagram for describing an aspect of evaluating performance of a detector related to a target intersection according to an embodiment of the present invention.

For example, the performance evaluation module 1300 may calculate a first similarity score by comparing the longitude/latitude data included in the PVD with the longitude/latitude data included in the object information on the object specified through operation S4100.

For example, the performance evaluation module 1300 may calculate a second similarity score by comparing the azimuth data included in the PVD with the azimuth data included in the object information on the object specified through operation S4100.

For example, the performance evaluation module 1300 may calculate a third similarity score by comparing the speed data included in the PVD with the speed data included in the object information on the object specified through operation S4100.

In the operation S4300 of evaluating the performance of the detector on the basis of the calculated similarity, the performance evaluation module 1300 of the electronic device 1000 may perform an operation of evaluating the performance of the detector on the basis of the first to third similarity scores calculated through operation S4200.

For example, the performance evaluation module 1300 may be implemented to determine that there is an abnormality in the performance (or angle of view) of the detector when at least one of the first to third similarity scores is lower than a preset threshold score. As another example, the performance evaluation module 1300 may be implemented to calculate a summed similarity score between the PVD and the object information on the basis of the first to third similarity scores calculated through operation S4200, and determine there is an abnormality in the performance (or the angle of view) of the detector when the calculated summed similarity score is lower than the preset threshold score. However, this is only exemplary, and the performance evaluation module 1300 may evaluate whether there is an abnormality in the performance of the detector for obtaining the object information on the basis of a similarity between the PVD and the object information, using any appropriate method.

Meanwhile in FIG. 6, it has been described that the object corresponding to the probe vehicle is identified by comparing the PVD with the object information and the performance of the detector is evaluated by additionally calculating the similarity between the object information on the identified object and the PVD. However, this is only for convenience of description and should not be construed for purposes of limitation. As described above, the performance evaluation module 1300 according to the embodiment of the present invention may be implemented to determine the performance of the detector depending on whether the object corresponding to the probe vehicle is identified in the image captured through the detector of the ITS. Specifically, the performance evaluation module 1300 may be implemented to determine that there is no abnormality in the performance of the detector when the object corresponding to the probe vehicle is identified in operation S4100, and determine that there is an abnormality in the performance of the detector when the object corresponding to the probe vehicle is not identified in operation S4100.

Referring to FIG. 3 again, the method of evaluating the performance of the detector according to the embodiment of the present invention may include the operation S5000 of transmitting the notification indicating that there is an abnormality in the detector on the basis of the result of the evaluation of the performance of the detector.

In the operation S5000 of transmitting the notification indicating that there is an abnormality in the detector on the basis of the result of the evaluation of the performance of the detector, the performance evaluation module 1300 of the electronic device 1000 may be implemented to transmit the notification indicating that there is an abnormality in the detector on the basis of the result of the evaluation of the performance of the detector in operation S4000 to the ITS server 200 through the communication module 1010. The notification may include a message, and include evaluation of the performance of the detector and identification information of the target intersection (i.e., ID of the target intersection), identification information of the detector (i.e., ID of the detector) determined that there is an abnormality, information (e.g., information on the similarity between the object information and the PVD) used to evaluate the performance of the detector, and/or any relevant information in any appropriate form indicating that there is an abnormality in the detector.

Meanwhile, the performance evaluation module 1300 according to the embodiment of the present invention may be implemented to transmit different types of notifications to the ITS server 200 depending on aspects of similarity scores.

For example, when a first similarity score for a similarity between the longitude/latitude data of the PVD and the longitude/latitude data of the object information is lower than a preset threshold score, there is a high possibility that there is a problem with an angle of view of the detector. Therefore, when the first similarity score is lower than the preset threshold score, the performance evaluation module 1300 may be implemented to transmit a notification including a first message indicating that there is a possibility of a problem with the angle of view of the detector to the ITS server 200.

As another example, when a second similarity score for a similarity between the azimuth data of the PVD and the azimuth data of the object information or a third similarity score for a similarity between the speed data of the PVD and the azimuth data of the object information is lower than a preset threshold score, it is highly likely that it is a technical problem, not a problem with the angle of view of the detector. Therefore, when the second similarity score or the third similarity score is lower than the preset threshold score, the performance evaluation module 1300 may be implemented to transmit a notification including a second message indicating that there is a possibility that a technical problem is present, to the ITS server 200.

According to the method of evaluating the performance of the detector of the ITS, the device for performing the same and the performance evaluation system according to the embodiments of the present invention, the performance of the detector can be automatically evaluated by comparing PVD of a probe vehicle with object information analyzed through the detector.

According to the method of evaluating the performance of the detector of the ITS, the device for performing the same and the performance evaluation system according to the embodiments of the present invention, by identifying a target intersection corresponding to an intersection region where a probe vehicle enters and evaluating the performance of the detector on the basis of object information detected from the detector of the identified target intersection, an intersection and a detector with an abnormality in performance can be identified.

According to the method of evaluating the performance of the detector of the ITS, the device for performing the same and the performance evaluation system according to the embodiments of the present invention, when there is an abnormality in the performance of the detector, by providing identification information of the detector with an abnormality and identification information of an intersection to which the detector belongs, operator convenience can be increased and a time required to identify the detector with an abnormality can be reduced.

According to the method of evaluating the performance of the detector of the ITS, the device for performing the same and the performance evaluation system according to the embodiments of the present invention, the performance of the detector can be automatically evaluated by comparing PVD of a probe vehicle with object information analyzed through the detector.

According to the method of evaluating the performance of the detector of the ITS, the device for performing the same and the performance evaluation system according to the embodiments of the present invention, by identifying a target intersection corresponding to an intersection region where a probe vehicle enters and evaluating the performance of the detector on the basis of object information detected from the detector of the identified target intersection, an intersection and a detector with an abnormality in performance can be identified.

According to the method of evaluating the performance of the detector of the ITS, the device for performing the same and the performance evaluation system according to the embodiments of the present invention, when there is an abnormality in the performance of the detector, by providing identification information of the detector with an abnormality and identification information of an intersection to which the detector belongs, operator convenience can be increased and a time required to identify the detector with an abnormality can be reduced.

Effects of the present invention are not limited to the above-described effects and other effects that are not described may be clearly understood by those skilled in the art from the above detailed descriptions.

Features, structures, and effects described in the above-described exemplary embodiments are included in at least one exemplary embodiment of the present invention, but are not necessarily limited to only one exemplary embodiment. Furthermore, features, structures, and effects described in each embodiment can be combined or modified and implemented in other embodiments by one of ordinary skill in the art to which the embodiments belong. Therefore, it should be interpreted that contents related to such combinations and modifications are included in the scope of the present invention.

Further, while the present invention has been particularly described with reference to embodiments, the embodiments are only exemplary embodiments of the present invention and the present invention is not intended to be limited thereto. It will be understood by those skilled in the art that modifications and applications in other forms may be made without departing from the spirit and scope of the present invention. That is, each element specifically shown in the embodiments may be modified and embodied. In addition, it should be understood that differences related to these modifications and applications are within the scope of the present invention as defined in the appended claims.

What is claimed is:

1. A method of evaluating performance of a detector of an intelligent transport system (ITS) using an electronic device, the method comprising:
obtaining probe vehicle data (PVD) of a probe vehicle;
identifying a target intersection as an evaluation target on the basis of the PVD and pre-stored information on an intersection region;
obtaining object information of the target intersection from the ITS;
evaluating the performance of the detector related to the target intersection on the basis of the PVD and the object information; and
transmitting a notification indicating that there is an abnormality in the detector on the basis of a result of the evaluating of the performance of the detector.

2. The method of claim 1, wherein the evaluating of the performance of the detector related to the target intersection further includes:
comparing the PVD with the object information and determining whether an object corresponding to the probe vehicle in an image captured through the detector of the ITS is identified; and
when it is determined that the object corresponding to the probe vehicle is identified, determining that there is no abnormality in the performance of the detector, and when it is determined that the object corresponding to the probe vehicle is not identified, determining that there is an abnormality in the performance of the detector.

3. The method of claim 2, wherein the determining whether the object corresponding to the probe vehicle is identified further includes:
comparing an object trajectory calculated from the PVD with candidate object trajectories calculated from the object information; and
when a similarity of the candidate object trajectories and the object trajectory calculated from the PVD is greater than or equal to a threshold value, determining that the object corresponding to the probe vehicle is identified, and when the similarity of the candidate object trajectories and the object trajectory calculated from the PVD is less than the threshold value, determining that the object corresponding to the probe vehicle is not identified.

4. The method of claim 1, wherein the evaluating of the performance of the detector related to the target intersection further includes:
comparing the PVD with the object information and identifying an object corresponding to the probe vehicle in an image captured through the detector of the ITS;
calculating a similarity between the object information on the identified object and the PVD; and
evaluating the performance of the detector on the basis of the calculated similarity.

5. The method of claim 1, wherein the identifying of the target intersection further includes identifying an intersection corresponding to the information on the intersection region into which the probe vehicle enters as the target intersection on the basis of longitude and latitude data included in the PVD and the information on the intersection region.

6. The method of claim 4, wherein the identifying of the object corresponding to the probe vehicle further includes:
comparing license plate information pre-linked to terminal ID data included in the PVD with license plate data included in the object information; and
determining an object corresponding to the license plate data included in the object information that matches the pre-linked license plate information as the object corresponding to the probe vehicle.

7. The method of claim 4, wherein the identifying of the object corresponding to the probe vehicle further includes:
comparing an object trajectory calculated from longitude and latitude data included in the PVD with candidate object trajectories of a plurality of objects that are calculated from longitude and latitude data of the object information; and
identifying an object corresponding to a candidate object trajectory with a highest similarity to the object trajectory calculated from the PVD, among the candidate object trajectories, as the object corresponding to the probe vehicle.

8. The method of claim 4, wherein the calculating of the similarity between the object information on the identified object and the PVD further includes:
calculating a first similarity score between longitude and latitude data included in the object information of the identified object and longitude and latitude data included in the PVD;
calculating a second similarity score between azimuth data included in the object information of the identified object and azimuth data included in the PVD; and
calculating a third similarity score between speed data included in the object information of the identified object and speed data included in the PVD.

9. The method of claim 8, wherein the evaluating of the performance of the detector further includes, when at least one of the first to third similarity scores is lower than a preset first threshold score, determining that there is an abnormality in the performance of the detector.

10. The method of claim 8, wherein the evaluating of the performance of the detector further includes:
calculating a summed similarity score on the basis of the first to third similarity scores; and
when the summed similarity score is lower than a preset second threshold score, determining that there is an abnormality in the performance of the detector.

11. The method of claim 1, wherein the PVD includes terminal ID data, time data, longitude and latitude data, azimuth data, or speed data of the probe vehicle.

12. The method of claim 1, wherein the object information includes longitude and latitude data, azimuth data, speed data, or license plate data of at least one object detected from the image of the ITS.

13. The method of claim 1, wherein the notification includes identification information of the target intersection, and identification information of the detector which is abnormal.

14. The method of claim 1, wherein the obtaining of the PVD of the probe vehicle further includes:
transmitting identification information of a terminal that is mounted on the probe vehicle and pre-stored in the electronic device; and
receiving the PVD corresponding to the identification information of the terminal.

15. The method of claim 1, wherein the obtaining of the object information of the target intersection from the ITS further includes:
calculating an entry time point at which the probe vehicle enters the target intersection and an exit time point at which the probe vehicle exits from the target intersection on the basis of time data of the PVD; and
obtaining the object information detected from an image corresponding to a section between the entry time point and the exit time point from the ITS.

16. A non-transitory computer-readable recording medium on which a computer program executed by a computer is recorded, the computer program comprising:
obtaining probe vehicle data (PVD) of a probe vehicle;
identifying a target intersection as an evaluation target on the basis of the PVD and pre-stored information on an intersection region;
obtaining object information of the target intersection from the ITS;
evaluating the performance of the detector related to the target intersection on the basis of the PVD and the object information; and
transmitting a notification indicating that there is an abnormality in the detector on the basis of a result of the evaluating of the performance of the detector.

17. An electronic device comprising:
a communication module configured to receive probe vehicle data (PVD) of a probe vehicle and detection data of an intelligent transport system (ITS); and
a processor configured to evaluate performance of a detector of the ITS on the basis of the PVD and the detection data,
wherein the processor is configured to:
obtain the PVD of the probe vehicle;
identify a target intersection as an evaluation target on the basis of the PVD and pre-stored information on an intersection region;
obtain object information of the target intersection from the ITS;
evaluate performance of the detector related to the target intersection on the basis of the PVD and the object information; and
transmit a notification indicating that there is an abnormality in the detector on the basis of a result of the evaluation of the performance of the detector.
